(19) United States
(12) Patent Application Publication
(10) Pub. No.: US 2014/0341034 A1
(43) Pub. Date: Nov. 20, 2014

(54) TRANSMISSION MANAGEMENT DEVICE, SYSTEM, AND METHOD

(71) Applicant: POWER-ALL NETWORKS LIMITED, Shatin (HK)

(72) Inventor: STEVE LAP WAI HUI, Shatin (HK)

(73) Assignee: POWER-ALL NETWORKS LIMITED, Shatin (HK)

(21) Appl. No.: 14/278,704

(22) Filed: May 15, 2014

(30) Foreign Application Priority Data
May 16, 2013 (CN) 2013101815058

(51) Int. Cl. H04L 12/803

(52) U.S. Cl. CPC H04L 47/122
USPC 370/235

(57) ABSTRACT

In a transmission management method, a workload of a transmission path when a first electronic device communicates with a second electronic device is detected. Other transmission paths between the first electronic device and the second electronic device according to location information of routers, the first electronic device, and the second electronic device are detected when the workload of the current transmission path is heavy. An optimal transmission path of the other transmission paths is detected according to the workloads of the transmission paths. The first electronic device is controlled to communicate with the second electronic device via the determined optimal transmission path.

### CROSS REFERENCE TO RELATED APPLICATIONS

This application is related to the following co-pending, commonly assigned patent applications, the disclosures of which are incorporated herein by reference in their entirety:

1. “TRANSMISSION MANAGEMENT DEVICE, SYSTEM, AND METHOD” by Steve Lap Wai Hui, whose Attorney Docket No is US51795.

2. “TRANSMISSION MANAGEMENT DEVICE, SYSTEM, AND METHOD” by Steve Lap Wai Hui, whose Attorney Docket No is US51796.

3. “TRANSMISSION MANAGEMENT DEVICE, SYSTEM, AND METHOD” by Steve Lap Wai Hui, whose Attorney Docket No is US51797.

### FIELD

The present disclosure relates to a device, and more particularly to a transmission management device, a system, and a method thereof.

### BACKGROUND

Electronic devices, such as mobile phones and tablet computers, can communicate with each other and access a network via corresponding networks. An electronic device can connect to a network according to a certain network bandwidth assigned by a corresponding network operator. However, in some situations, when electronic devices connect to networks according to a certain network bandwidth assigned by a corresponding network operator, and when the number of people accessing the network is great, the resulting access speed can be very slow.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of a transmission management device.

FIG. 2 is a schematic diagram of a first embodiment of a transmission path.

FIG. 3 is a schematic diagram of a second embodiment of a transmission path.

FIG. 4 is a flowchart of an embodiment of a transmission management method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

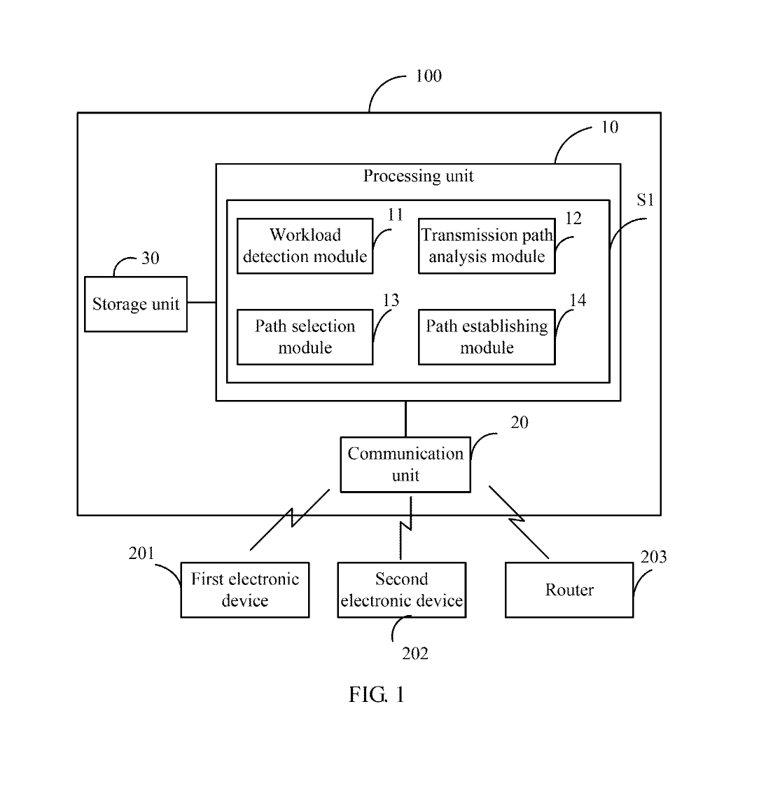

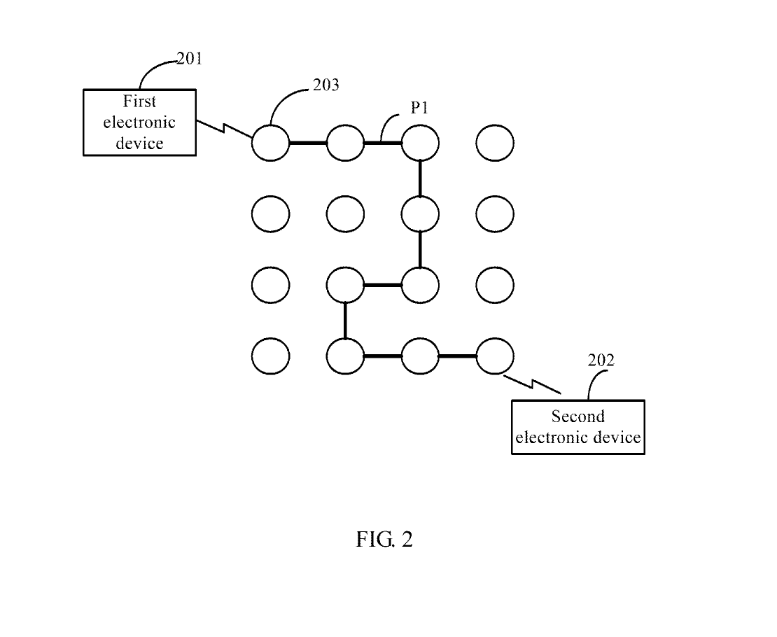

Referring to FIGS. 1-2, a transmission management device 100 includes a processing unit 10, a communication unit 20, and a storage unit 30.

The transmission management device 100 connects to at least a first electronic device 201, a second electronic device 202, and a number of routers 203 via the communication unit 203. The routers 203 can belong to different network operators or to the same network operator. The communication unit 20 connects the transmission management device 100 to the first electronic device 201, the second electronic device 202, and the routers 203 via corresponding networks, such as the Internet, a wireless network such as WIFI or BLUETOOTH, a telecommunication network such as a general packet radio service (GPRS) network or a code division multiple access (CDMA) network, or a broadcasting network.

The storage unit 30 stores location information of each router 203. The location information of each router 203 includes a geographic location and an Internet protocol (IP) address of the router 203.

In the embodiment, the storage unit 30 further includes a transmission management system S1. The transmission management system S1 includes a number of modules, which are a collection of software instructions and are executed by the processing unit 10 of the transmission management device 100. The modules include a workload detection module 11, a transmission path analysis module 12, a path selection module 13, and a path establishing module 14. In the embodiment, the storage unit 30 can be a hard disk, a compact disk, or a flash memory, for example. The processing unit 10 can be a central processing unit, a digital processor, or a single chip, for example.

As shown in FIG. 2, the workload detection module 11 is used to detect a workload of the transmission path P1 when the first electronic device 201 communicates with the second electronic device 202 via the transmission path P1.

In detail, when the first electronic device 201 communicates with the second electronic device 202, the connection between the first electronic device 201 and the second electronic device 202 is established via the transmission path P1 constituted by a number of routers 203. The workload detection module 11 detects the workload of the transmission path P1 by determining workloads of the routers 203. In more detail, the workload detection module 11 determines which routers 203 of the transmission path P1 have workloads greater than a predetermined workload, and then determines whether the workload of the transmission path P1 is heavy by judging whether a number of routers 203 with workloads greater than the predetermined workload is greater than a predetermined number, of the transmission path P1. That is, when the workload detection module 11 determines that the number of routers 203 of the transmission path P1 with workloads greater than the predetermined workload is greater than the predetermined number, the workload detection module 11 determines that the workload of the transmission path P1 is heavy. In the embodiment, the predetermined workload is 50%, and the predetermined number is five.

In the embodiment, the workload of the router 203 is a network utilization ratio of the router 203. The network utilization ratio is the ratio of current network traffic to the maximum network traffic that the router 203 can handle. When more data are transmitted/received and processed by the router 203, the network utilization ratio increases, and the workload of the router 203 becomes heavier. In the embodiment, the workload detection module 11 determines that the workload of the router 203 is greater than the predetermined workload when the network utilization ratio is greater than 50%.

When the workload detection module 11 determines that the workload of the transmission path P1 is heavy, the transmission path analysis module 12 obtains location information of the first electronic device 201 and the second electronic device 202, and determines another transmission path P1 between the first electronic device 201 and the second electronic device 202 according to the location information of the routers 203. In detail, the transmission path analysis module 12 first determines routers 203 between the first electronic device 201 and the second electronic device 202 according to the location information of the routers 203, the first electronic device 201, and the second electronic device 202. The transmission path analysis module 12 then determines the transmission paths P1 between the first electronic device 201 and the second electronic device 202.

In the embodiment, the location information of the first electronic device 201 and the second electronic device 202 is obtained by the transmission path analysis module 12 when the first electronic device 201 communicates with the second electronic device 202. In the embodiment, the location information of the first electronic device 201 includes a geographic location and an Internet protocol (IP) address of the first electronic device 201, and the location information of the second electronic device 202 includes a geographic location and an IP address of the second electronic device 202. The transmission path analysis module 12 determines the geographic locations of the first electronic device 201 and the second electronic device 202 according to the location information, and then determines the routers 203 with geographic locations between the geographic locations of the first electronic device 201 and the second electronic device 202.

In another embodiment, the location information of the first electronic device 201 only includes the IP address of the first electronic device 201, and the location information of the second electronic device 202 only includes the IP address of the second electronic device 202. The transmission path analysis module 12 locates the geographic locations of the first electronic device 201 and the second electronic device 202 according to the IP addresses of the first electronic device 201 and the second electronic device 202, based on the global positioning system. The transmission path analysis module 12 then determines the geographic locations of the first electronic device 201 and the second electronic device 202 according to the location information, and then determines the routers 203 with geographic locations between the geographic locations of the first electronic device 201 and the second electronic device 202.

The workload detection module 11 also detects workloads of other transmission paths P1 determined by the transmission path analysis module 12.

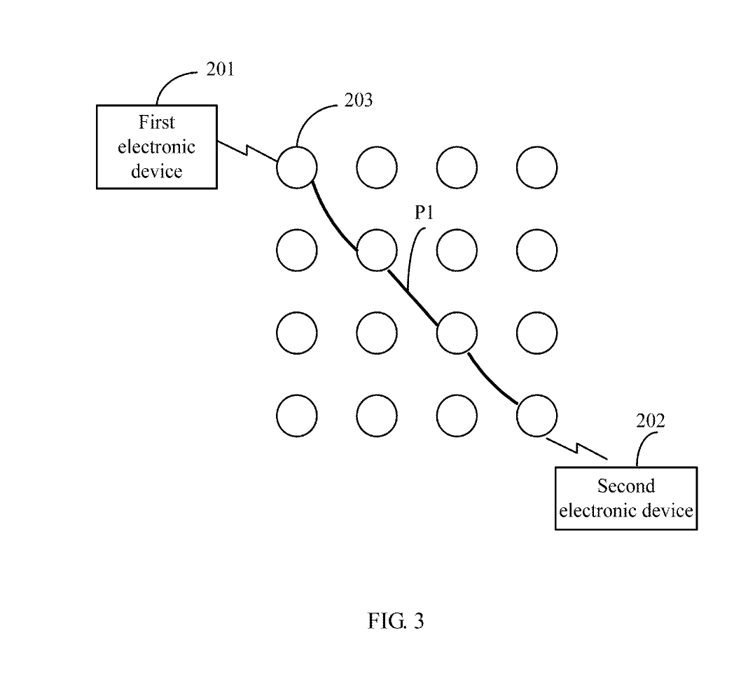

Referring to FIG. 3, the path selection module 13 determines an optimal transmission path P1 from the transmission paths P1 according to workloads of the other transmission paths P1 detected by the workload detection module 11. In the embodiment, the path selection module 13 selects a transmission path P1 that has a minimum workload of the detected transmission paths P1 as the optimal transmission path. In another embodiment, the path selection module 13 also determines transmission distances of the transmission paths P1 between the first electronic device 201 and the second electronic device 202, and determines the optimal transmission path according to workloads and transmission distances of the transmission paths P1 between the first electronic device 201 and the second electronic device 202. For example, the path selection module 13 determines a transmission path P1 that does not have a heavy workload and has the shortest transmission distance.

For example, FIG. 3 illustrates that if the workloads of the routers 203 located between the first electronic device 201 and the second electronic device 202 are all less than the predetermined workload, the path selection module 13 determines that the transmission path P1 along the shortest transmission distance, namely the diagonal line as shown in FIG. 3, is the shortest transmission path P1. Then, the routers 203 located along the shortest transmission path P1 are selected.

The path establishing module 14 controls the first electronic device 201 and the second electronic device 202 to communicate with each other via the optimal transmission path P1 according to the optimal transmission path P1 determined by the path selection module 13.

Thus, when the workload of the current transmission path P1 used by the first electronic device 201 and the second electronic device 202 is heavy, the transmission management device 100 can provide another transmission path P1 whose workload is lighter to the first electronic device 201 and the second electronic device 202.

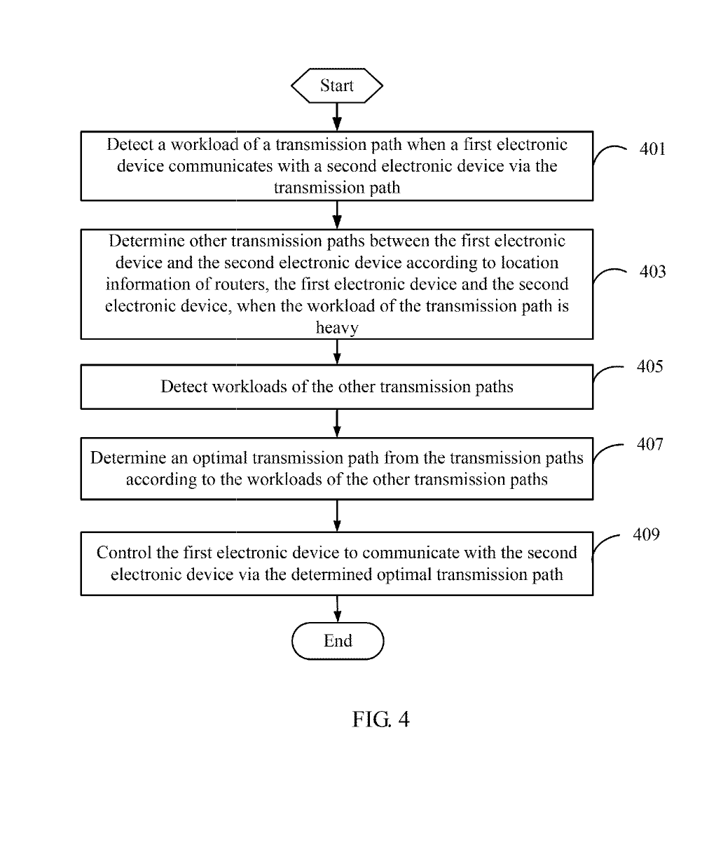

FIG. 4 illustrates a flowchart of a transmission management method. In 401, the workload detection module 11 detects a workload of a transmission path P1 when the first electronic device 201 communicates with the second electronic device 202 via the transmission path P1. In the embodiment, the workload detection module 11 detects the workload of the transmission path P1 by determining workloads of the at least one router 203 constituting the transmission path P1.

In 403, when the workload detection module 11 determines the workload of the transmission path P1 currently used by the first electronic device 201 and the second electronic device 202 is heavy, the transmission path analysis module 12 obtains location information of the first electronic device and the second electronic device, and determines other transmission paths P1 between the first electronic device 201 and the second electronic device 202 according to the location information of the routers stored in the storage unit 30, and location information of the first electronic device 201 and the second electronic device 202. In detail, the transmission path analysis module 12 first determines routers 203 between the first electronic device 201 and the second electronic device 202 according to the location information of the routers 203, the location information of the first electronic device 201 and the second electronic device 202. The transmission path analysis module 12 then determines the transmission paths P1 between the first electronic device 201 and the second electronic device 202 according to the routers 203 between the first electronic device 201 and the second electronic device 202.

In 405, the workload detection module 11 also detects workloads of the other transmission paths P1 determined by the transmission path analysis module 12.

In 407, the path selection module 13 determines an optimal transmission path from the transmission paths P1 according to the workloads of the other transmission paths P1 detected by the workload detection module 11.

In 409, the path establishing module 14 controls the first electronic device 201 and the second electronic device 202 to communicate with each other via the optimal transmission path determined by the path selection module 13.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A transmission management system, applied to a transmission management device comprising a storage unit and a communication unit for connecting to a first electronic device, a second electronic device, and a plurality of routers, the system comprising:
a processing unit; and
a plurality of modules which are collection of instructions executed by the processing unit, the modules comprising:
a workload detection module configured to detect a workload of a transmission path when the first electronic device communicates with the second electronic device via the transmission path;
a transmission path analysis module configured to obtain location information of the first electronic device and the second electronic device, and to determine other transmission paths between the first electronic device and the second electronic device according to the location information of the routers stored in the storage unit and the location information of the first electronic device and the second electronic device, when the workload detection module detects the workload of the transmission path currently used by the first electronic device and the second electronic device is heavy; wherein, the workload detection module further detects workload of other transmission paths;
a path selection module configured to determine a optimal transmission path from the other transmission paths according to workloads of the other transmission paths detected by the workload detection module; and
a path establishing module configured to control the first electronic device and the second electronic device to communicate with each other via the optimal transmission path determined by the path selection module.

2. The system according to claim 1, wherein the workload detection module determines the routers of the transmission path with workloads greater than a predetermined workload, and then determines whether the workload of the transmission path is heavy by judging whether an amount of the routers with workloads greater than the predetermined workload of the transmission path is greater than a predetermined number.

3. The system according to claim 1, wherein the transmission path analysis module first determines routers between the first electronic device and the second electronic device according to the location information of the routers, the location information of the first electronic device and the second electronic device, the transmission path analysis module then determines the transmission paths between the first electronic device and the second electronic device according to the routers between the first electronic device and the second electronic device.

4. The system according to claim 3, wherein the transmission path analysis module obtains the location information of the first electronic device and the second electronic device when the first electronic device communicates with the second electronic device, the location information of the first electronic device comprises a geographic location and an internet protocol (IP) address of the first electronic device, and the location information of the second electronic device comprises a geographic location and an IP address of the second electronic device, the transmission path analysis module determines the geographic locations of the first electronic device and the second electronic device according to the location information, and then determines the routers with geographic locations between the geographic locations of the first electronic device and the second electronic device.

5. The system according to claim 3, wherein the location information of the first electronic device comprises an IP address of the first electronic device, and the location information of the second electronic device comprises an IP address of the second electronic device, the transmission path analysis module locates the geographic locations of the first electronic device and the second electronic device according to the IP addresses of the first electronic device and the second electronic device, based on the global position system, and then determines the geographic locations of the first electronic device and the second electronic device according to the location information, and then determines the routers with geographic locations between the geographic locations of the first electronic device and the second electronic device.

6. The system according to claim 1, wherein the path selection module further determines transmission distances of each transmission path between the first electronic device and the second electronic device, and determines the optimal transmission path according to workloads and transmission distances of the transmission paths between the first electronic device and the second electronic device.

7. A transmission management device, comprising:
a communication unit configured to communicate with a first electronic device, a second electronic device and a plurality of routers;
a storage unit configured to store location information of the plurality of routers, the location information comprising geographic location of the plurality of routers;
a processing unit configured to execute a plurality of modules which are collection of instructions, the modules comprising:
a workload detection module configured to detect a workload of a transmission path when the first electronic device communicates with the second electronic device via the transmission path;
a transmission path analysis module configured to obtain location information of the first electronic device and the second electronic device, and to determine other transmission paths between the first electronic device and the second electronic device according to the location information of the routers stored in the storage unit and the location information of the first electronic device and the second electronic device, when the workload detection module detects the workload of the transmission path currently used by the first electronic device and the second electronic device is heavy; wherein, the workload detection module further detects workload of other transmission paths;
a path selection module configured to determine a optimal transmission path from the other transmission paths according to workloads of the other transmission paths detected by the workload detection module; and
a path establishing module configured to control the first electronic device and the second electronic device to communicate with each other via the optimal transmission path determined by the path selection module.

8. The device according to claim 7, wherein the workload detection module determines the routers of the transmission path with workloads greater than a predetermined workload, and then determines whether the workload of the transmission path is heavy by judging whether an amount of the routers with workloads greater than the predetermined workload of the transmission path is greater than a predetermined number.

9. The device according to claim 7, wherein the transmission path analysis module first determines routers between the first electronic device and the second electronic device according to the location information of the routers, the location information of the first electronic device and the second electronic device, the transmission path analysis module then determines the transmission paths between the first electronic device and the second electronic device according to the routers between the first electronic device and the second electronic device.

10. The device according to claim 9, wherein the transmission path analysis module obtains the location information of the first electronic device and the second electronic device when the first electronic device communicates with the second electronic device, the location information of the first electronic device comprises a geographic location and an internet protocol (IP) address of the first electronic device, and the location information of the second electronic device comprises a geographic location and an IP address of the second electronic device, the transmission path analysis module determines the geographic locations of the first electronic device and the second electronic device according to the location information, and then determines the routers with geographic locations between the geographic locations of the first electronic device and the second electronic device.

11. The device according to claim 9, wherein the location information of the first electronic device comprises an IP address of the first electronic device, and the location information of the second electronic device comprises an IP address of the second electronic device, the transmission path analysis module locates the geographic locations of the first electronic device and the second electronic device according to the IP addresses of the first electronic device and the second electronic device, based on the global position system, and then determines the geographic locations of the first electronic device and the second electronic device according to the location information, and then determines the routers with geographic locations between the geographic locations of the first electronic device and the second electronic device.

12. The device according to claim 7, wherein the path selection module further determines transmission distances of each transmission path between the first electronic device and the second electronic device, and determines the optimal transmission path according to workloads and transmission distances of the transmission paths between the first electronic device and the second electronic device.

13. A transmission management method, applied in a transmission management device comprising a storage unit, the method comprising:
detecting a workload of a transmission path when a first electronic device communicates with a second electronic device via the transmission path;
obtaining location information of the first electronic device and the second electronic device, and determining other transmission paths between the first electronic device and the second electronic device according to the location information of routers stored in the storage unit, and the obtained location information of the first electronic device and the second electronic device, when workload of the transmission path currently used by the first electronic device and the second electronic device is heavy;
detecting workloads of other transmission paths;
determining an optimal transmission path from the transmission paths according to the workloads of the transmission paths; and
controlling the first electronic device to communicate with the second electronic device via the determined optimal transmission path.

14. The method according to claim 13, wherein the step of detecting a workload of a transmission path when a first electronic device communicates with a second electronic device via the transmission path comprises:
determining routers of the transmission path with workloads greater than a predetermined workload, and
determining whether the workload of the transmission path is heavy by judging whether an amount of the routers with workloads greater than the predetermined workload of the transmission path is greater than a predetermined number.

15. The method according to claim 13, wherein the step of determining an optimal transmission path from the transmission paths according to the workloads of the transmission paths comprises:
determining transmission distances of each transmission path between the first electronic device and the second electronic device, and
determining the optimal transmission path according to workloads and transmission distances of the transmission paths between the first electronic device and the second electronic device.

16. The method according to claim 13, wherein the step of determining other transmission paths between the first electronic device and the second electronic device according to the location information of routers stored in the storage unit, and the obtained location information of the first electronic device and the second electronic device comprises:
determining routers between the first electronic device and the second electronic device according to the location information of the routers, the location information of the first electronic device and the second electronic device; and
determining the transmission paths between the first electronic device and the second electronic device according to the routers between the first electronic device and the second electronic device.
